(19) United States
(12) Patent Application Publication
(10) Pub. No.: US 2014/0000191 A1
(43) Pub. Date: Jan. 2, 2014

(54) SHOULDER SPACER KEY FOR INSULATED GLAZING UNITS

(71) Applicant: SAGE Electrochromics, Inc., Faribault, MN (US)

(72) Inventors: Mark O. Snyker, Apple Valley, MN (US); Robert Anglemier, Waterville, MN (US); Bryan D. Greer, Northfield, MN (US); Rino Messere, Herzogenrath (DE); Jerome Korus, Lakeville, MN (US); Erik Bjornard, Northfield, MN (US)

(73) Assignee: SAGE Electrochromics, Inc., Faribault, MN (US)

(21) Appl. No.: 13/929,325

(22) Filed: Jun. 27, 2013

Related U.S. Application Data
(60) Provisional application No. 61/664,992, filed on Jun. 27, 2012.

(51) Int. Cl. E06B 3/66; E06B 3/667

(52) U.S. Cl. CPC E06B 3/66; E06B 3/667
USPC 52/204.593; 403/294

(57) ABSTRACT

An insulative separation element bridges first and second conductive spacer ends of a spacer frame of an active or insulated glazing unit. The insulative separation element includes first and second outer sections dimensioned for placement into the first and second conductive spacer ends. The insulative separation element includes an intermediate section connecting the first and second outer sections. The intermediate section has opposing first and second faces dimensioned for abutment with and insulative separation of the first and second spacer ends, respectively.

### CROSS-REFERENCE TO RELATED APPLICATIONS

The present application claims the benefit of the filing date of U.S. Provisional Patent Application No. 61/664,992 filed Jun. 27, 2012, the disclosure of which is hereby incorporated herein by reference.

### BACKGROUND OF THE INVENTION

Insulated glazing units (“IGU”), as that term is used herein, means two or more layers of glass, which are sometimes called glass lite panels, separated by a spacer frame along the edge and sealed to create a dead air (or other gas, e.g., argon, nitrogen, krypton) space between the layers. The spacer frame includes spacers, which are conventionally hollow tubes, also called spacer tubes, of a conductive material, such as but not limited to aluminum or steel, but which may not be hollow in some instances and which may be made of polymeric materials. The spacer frame, in some instances, may include a spacer key, which is sometimes called a spacer connector that is inserted into ends of spacers to bridge the ends together. Active glazings, which form a part of the IGU and which include electrochromic glazings, may be applied or deposited to one of the glass lite panels. An electrochromic glazing may have a laminate structure (see copending U.S. Patent Application Publication Nos. 2011/0261429 A1 and 2011/0267672 A1 and copending U.S. patent application Ser. Nos. 13/906,456 and 13/906,487, the disclosures of which are hereby incorporated by reference herein in their entireties). For example, the electrochromic glazings may include a series of thin films that are applied or deposited to one of the glass lite panels. Electrochromic glazings or coatings include electrochromic materials that are known to change their optical properties in response to the application of an electric potential which can create coloration or tinting within the electrochromic glazings. Common uses for these glazings include architectural windows, as well as windshields and mirrors of automobiles. Further details regarding the formation of IGUs can be found in, for example, U.S. Pat. Nos. 7,372,610 and 7,593,154, the entire disclosures of which are hereby incorporated by reference herein in their entireties.

As known to those of ordinary skill in the art, electrically conductive busbars are typically applied along the surface of one of the glass lite panels such that upon assembly of an IGU, the busbars are either outside an IGU spacer/polyisobutylene (“PIB”) seal (or “spacer seal” as that term is used herein) to form an IGU thermal break cavity; or the busbars are mainly inside the spacer seal. For example, as shown in FIG. 1, an IGU 1 may have a glass panel 2 on which a busbar 3 is applied such that the busbar 3 is mainly within a perimeter defined by sides of a spacer 5 and a spacer seal 4 placed between the spacer 5 and the glass panel 2 having approximately the same perimeter as the spacer 5. As shown, in such a configuration, the busbar 3 must be applied to extend under the spacer seal 4 to a region outside the perimeters of the spacer seal 4 and the spacer 5 to allow for the formation of a busbar solder tab 7 on an end of the busbar that provides a contact area to which a wire 9 can be soldered to provide a sufficient solder joint 8 for a consistent electrical connection. The busbar solder tab 7 must be placed such that there is sufficient clearance between the solder joint 8 and the spacer 5 to prevent electrical shorting due to undesired contact between the spacer 5 and the solder joint 8 during the assembly process or during slight movements that may occur over the useful life of the IGU. In addition, sufficient clearance is needed to provide space for a solder gun tip to land and create a solder joint and, in some instances, to permit the addition of a sealant onto the busbar and busbar solder tab after soldering to either or both prevent solder tab corrosion and prevent argon or other inert gases from exiting a cavity of the IGU defined by the spacer 5 and the spacer seal 4 as well as the spacer seal 14 opposing the spacing seal 4.

To provide sufficient clearance, the spacer 5 has been dimensioned to have a smaller perimeter than IGUs that do not require electrical connectivity. However, in certain architectural frame configurations, one or both of the smaller perimeter spacer and corresponding spacer seal is visible within the viewable area of the frame unless an obscuration mask is applied, such as described in U.S. patent application Ser. No. 13/797,610, the entire disclosure of which is hereby incorporated by reference herein in its entirety, which may be used to improve the aesthetic look of such an architectural glazing frame system but which may add cost while still causing a reduction in the viewable area of the frame as compared to IGUs not requiring electrical connectivity.

Thus, there exists a need for an electrical interconnection to busbars in an IGU cavity without requiring a reduction in the perimeter of a spacer to accommodate for such a connection.

### BRIEF SUMMARY OF THE INVENTION

In accordance with an aspect of an embodiment, an insulated glazing unit may include a non-conductive spacer key and a conductive spacer, which may be metallic. The spacer may be split into first spacer and second spacer sections. The spacer key may bridge the first and second spacer sections.

In accordance with an aspect of an embodiment, an insulative separation element may bridge first and second conductive spacer ends of a spacer frame of an active or insulated glazing unit. The insulative separation element may include first and second outer sections dimensioned for placement into the first and second conductive spacer ends of the spacer frame. The insulative separation element may include an intermediate section that may connect the first and second outer sections. The intermediate section may have opposing first and second faces dimensioned for abutment with and insulative separation of the first and second spacer ends, respectively.

In some arrangements, either or both of the first and second outer sections may have a base and may have opposing rails spaced apart and extending from and parallel to the base. The opposing rails and the base may define a fillable space. In some arrangements, the opposing rails may be dimensioned for compressive engagement with one or both of the first and second conductive spacer ends of the active or insulated glazing unit.

In some arrangements, a plurality of fins may extend from the rails. In some arrangements, the fins may extend at a first angle along a first portion of the rails and may extend at a second angle along a second portion of the rails.

In some arrangements, an underside of the base opposite the opposing rails may include cavities therein. In some arrangements, the intermediate section may define a bore through which material may pass from either of the first and second outer sections to the other of the first and second outer sections.

In some arrangements, an exterior of the intermediate section may define a groove. In some such arrangements, the insulative separation element may include a removable cover receivable in the groove. In some arrangements, the groove of the intermediate section may be formed on and may be bounded by inner and outer sides and a first end of the intermediate section in which the first end may be opposite a second end of the intermediate section such that a cross-section of the groove has a U-shape. In some arrangements, a cross-section of the removable cover may have a shape corresponding to the U-shape cross-section of the groove of the intermediate section. In this manner, upon placement of the removable cover onto the intermediate section, three surfaces of the removable cover may be flush against each of the inner and outer sides and the first end of the intermediate section, respectively. In some arrangements, the groove may form an insulative shoulder at the second end of the insulative separation element. In some arrangements, one of the intermediate section and the removable cover may include a protrusion or other type of embossment and the other of the intermediate section and the removable cover may include a protrusion groove dimensioned for receiving the protrusion such that when the protrusion is received in the protrusion groove, the removable cover is lockingly engaged with the intermediate section.

In some arrangements, the insulative separation element may include one or more fins may extend from at least one of the first and second outer sections. In some arrangements, the fins may extend from only an end portion of either or both of the first and second outer sections. In some arrangements, one or more of the fins may extend at an angle towards the intermediate section.

In some arrangements, the insulative separation element may include compressible protrusions or other type of bump or embossment extending from the outer sections. Such compressible protrusions may provide a press fit with the first and second conductive spacer ends of the spacer frame.

In some arrangements, the intermediate section may be a shoulder that may extend along only a portion of the perimeter of the intermediate section. In some arrangements, the outer sections may have a first central axis that may pass therethrough. In some such arrangements, the intermediate section may have a second central axis that may pass therethrough in which the first and second central axes may be either or both parallel to and offset from each other.

In some arrangements, the intermediate section may include a shoulder. In some such arrangements, the insulative separation element may include grooves that may be adjacent to the shoulder. In some such arrangements, the grooves may be defined by the intersection of the respective outer sections and the intermediate section.

In accordance with an aspect of an embodiment, an active or insulated glazing unit may include an insulative separation element and first and second spacer portions of a spacer frame. The first and second spacer portions may be conductive. The insulative separation element may be matingly engaged with the first and second spacer portions. The insulative separation element may electrically isolate the first and second spacer portions.

In some arrangements, the insulative separation element may include a shoulder. In some arrangements, the shoulder may have at least one shoulder surface that may abut a spacer surface of each of the first and second spacer portions. In this manner, in some arrangements, the insulative separation element and the first and second spacer portions may form a continuous common outer profile when the insulative separation element fully engages the first and second spacer portions.

In some arrangements, the insulative separation element may include a pair of outer sections for connecting the first and second spacer portions. In such arrangements, the outer sections may be separated by an intermediate section that may be connected to each of the outer sections. In some arrangements, a first longitudinal axis may pass through each of the first and second spacer portions. In some arrangements, a second longitudinal axis may pass through the intermediate section in which the first and second longitudinal axes may be either or both offset from and parallel to each other.

In some arrangements, the active or insulated glazing unit may include a plurality of spaced apart conductive traces deposited on a substrate thereof. In some such arrangements, the insulative separation element may include an insulative shoulder element along a side thereof. In some such arrangements, upon contact of the insulative separation element with a corresponding conductive trace, the insulative shoulder element may contact a corresponding one of the conductive trace such that no electrical interconnection is formed between the insulative separation element and the corresponding conductive trace.

In some arrangements, the insulative separation element may include a pair of outer sections for connecting the first and second spacer portions in which the outer sections may separated by an intermediate section connected to the outer sections. In some such arrangements, the outer sections of the insulative separation element may be compressively received within the first and second spacer portions. In some arrangements, the insulative separation element may include separated shoulders defining a gap. In some such arrangements, the active or insulated glazing unit may include a sealing material that may be placed within the gap.

In some arrangements, the insulative separation element may include an outer section and a shelf that may be connected to each other by an intermediate section. In some such arrangements, the outer section and the shelf may connect the first and second spacer portions.

In some arrangements, the first spacer portion may include a tongue that rests on the shelf of the insulative separation element. In some arrangements, the tongue of the first spacer portion may be received within the outer section of the insulative separation element. In some arrangements, the outer section of the insulative separation element may be received within the second spacer portion.

In some arrangements, the active or insulated glazing unit may include a third spacer portion. In some arrangements, the active or insulated glazing unit may include a second insulative separation element on a side of the first spacer portion opposite the insulative separation element. In some such arrangements, the second insulative separation element may electrically isolate the first spacer portion from the third spacer portion. In some arrangements, the first spacer portion may form a corner of the active or insulated glazing unit.

### BRIEF DESCRIPTION OF THE DRAWINGS

FIG. 1 is a perspective view of a portion of an IGU, as known in the prior art.

FIG. 2A is a partially cutaway perspective view of an IGU in accordance with an embodiment.

FIG. 2B is an exploded view of portions of a spacer frame of the IGU of FIG. 2A.

FIG. 3A is an exploded view of portions of a spacer frame in accordance with an embodiment.

FIG. 3B is a partially cutaway perspective view of an IGU including the spacer frame shown in FIG. 3A in accordance with an embodiment.

FIG. 4A is a perspective view of a spacer key in accordance with an embodiment.

FIGS. 4B and 4C are a plan and elevation views of a portion of an IGU including the spacer key shown in FIG. 4A in accordance with an embodiment.

FIG. 5 is a perspective view of a spacer key in accordance with an embodiment.

FIGS. 6A and 6B are front and rear perspective views of a spacer key in accordance with an embodiment.

FIG. 6C is a perspective view of a portion of a spacer frame including a portion of the spacer key shown in FIGS. 6A and 6B in accordance with an embodiment.

FIGS. 7A and 7B are front and rear perspective views of a spacer key in accordance with an embodiment.

FIG. 7C is a perspective view of a portion of a spacer frame including a portion of the spacer key shown in FIGS. 7A and 7B in accordance with an embodiment.

FIGS. 8A and 8B are perspective views of portions of spacer frames in accordance with an embodiment.

FIG. 9 is a perspective view of a portion of an IGU in accordance with an embodiment.

FIG. 10 is a perspective view of a portion of an IGU in accordance with an embodiment.

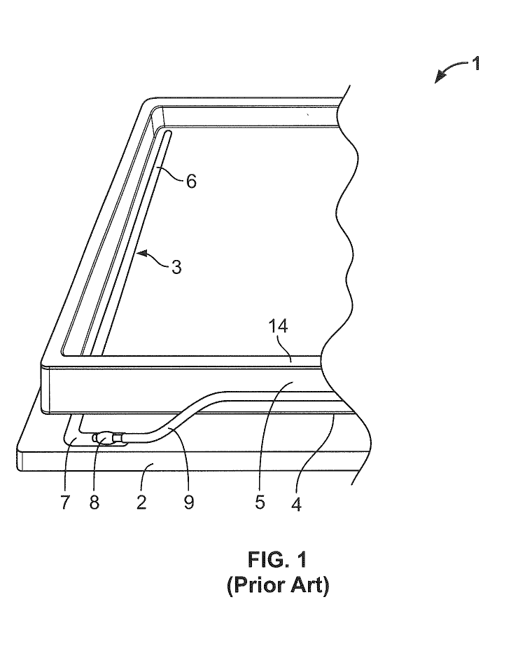

### DETAILED DESCRIPTION

As used herein, the terms “width” and “length” refer to directions parallel to parallel surfaces of a substrate, such as a glass panel. The term “thickness” is used to refer to a dimension measured in a direction perpendicular to the parallel surfaces of such a substrate. The term “rear” refers to directions away from an IGU cavity and parallel to the direction of the width directions of features whereas the term “front” refers to directions towards the IGU cavity and parallel to the direction of the width directions of features.

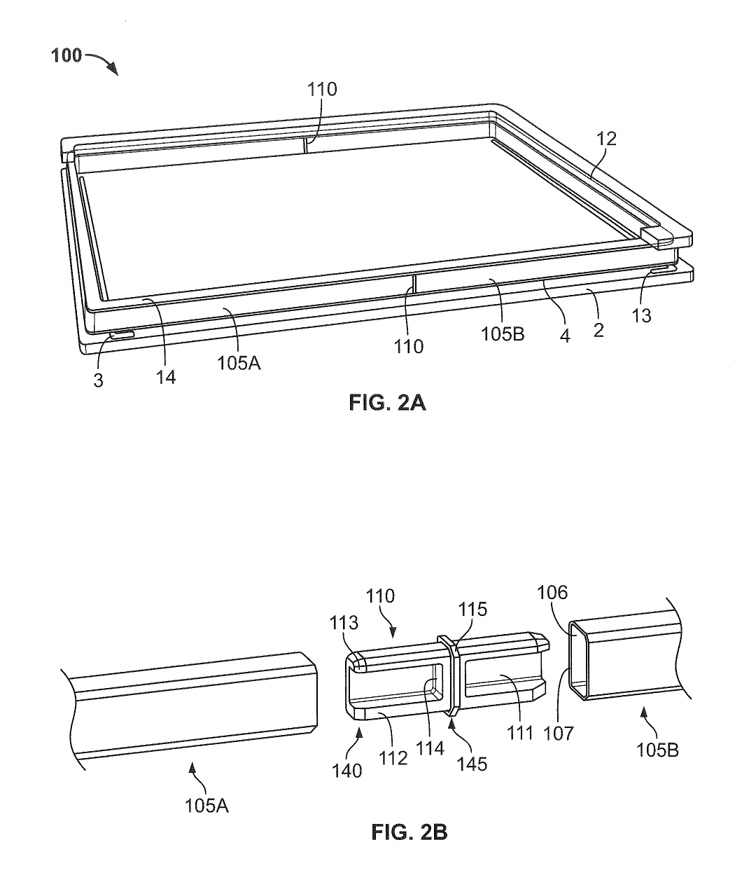

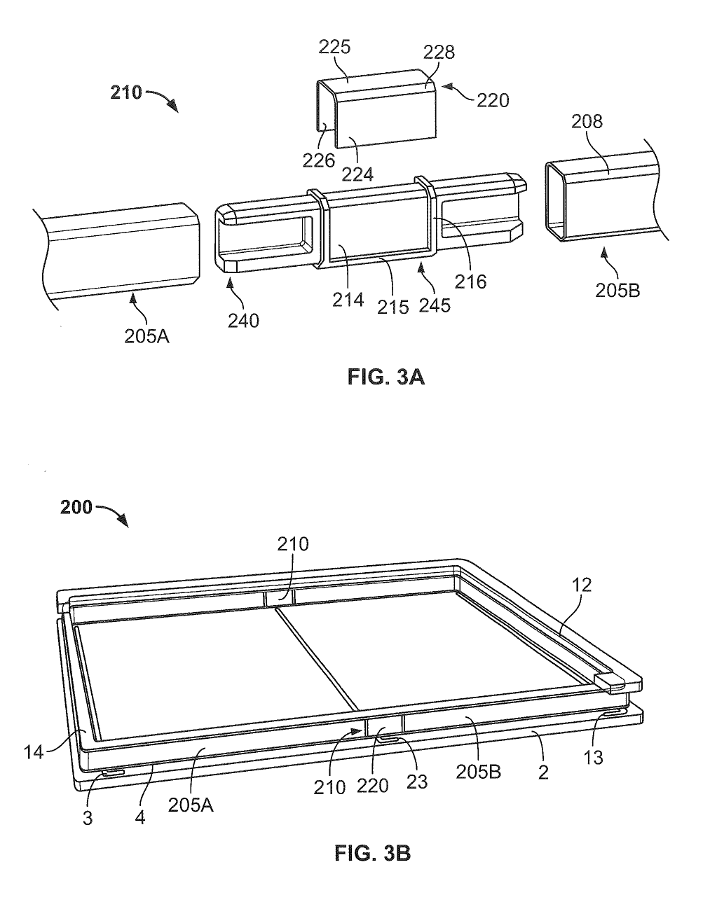

Referring now to the drawings, as shown in FIGS. 2A and 2B, an IGU 100 may include first and second spacer portions 105A, 105B of a spacer that may be separated along their lengths by spacer keys 110 such that the spacer portions 105A, 105B do not physically contact each other. In some arrangements, such as those of FIG. 2A, the spacer portions 105A, 105B may be formed by preparing a gap within a continuous spacer. Such gaps may be formed by sawing or laser cutting out a section of a spacer. In some arrangements, the removed section of the spacer may be sized to correspond with a shoulder of a spacer key, such as a shoulder 115 of the spacer key 110 described further herein. In other arrangements, the removed sections may be of other widths, e.g., a width of the sections removed for the arrangement shown in FIG. 3B may be greater than the width of the sections removed in the arrangement of FIG. 2A.

In some arrangements, the spacer may be made of materials such as but not limited to aluminum, steel, stainless steel, copper, beryllium copper, brass, tin, nickel, silver, titanium, nickel titanium, and other rigid metals, rigid woven materials, plastics, resins, or blends of plastics or polymers or other composite materials. The spacer preferably may be non-permeable or substantially nonpermeable. As shown in FIGS. 2A and 2B, in some arrangements, the spacer portions 105A, 105B may be electrically conductive.

As shown in FIG. 2A, the IGU 100 may include the spacer seals 4, 14 between the respective glass lite panels 2, 12 and a spacer frame positioned between both of the spacer seals 4, 14 in which the spacer frame is formed by the assembly of the spacer portions 105A, 105B and the spacer key 110. As further shown in FIG. 2A, the IGU 100 may include a conductive busbars 3, 13 that may be applied, such as by a printing process known to those of ordinary skill, to the glass lite panel 2 and may be separated a distance across the panel 2 in which the busbar 3 extends under only the spacer portion 105A and the busbar 13 extends under only the spacer portion 105B. In this manner, the busbars 3, 13 may be separated on opposite ends of the spacer frame in which such opposite ends are defined by a plane perpendicular to each of the opposing spacer keys 110.

As best shown in FIG. 2B, the spacer key 110 may include outer sections 140 on opposing sides of an intermediate section 145. As shown, each the outer sections 140 may include a base 111 and a pair of side rails 112 extending along the base for insertion into ends of the respective spacers 105A, 105B. As in this example, a thickness of the base 111 and the side rails 112 may be dimensioned such that a compression, i.e., an interference fit, is formed between the spacer key 110 and inner surfaces 106 of the respective spacers 105A, 105B through which the spacer key 110 is inserted.

As further shown, the side rails 112 may extend at the edges and along the length of the spacer key 110. In this manner, the side rails 112 may contact the respective spacer 105A, 105B, over a larger surface area than if the side rails were located more centrally, i.e., not along the edges of the spacer key 110. As further shown, ends of the side rails 112 furthest from the intermediate section 145 may have a radius 113 that may reduce the initial effort required to insert the outer sections 140 of the spacer key 110 into the ends of the respective spacers 105A, 105B. In some alternative arrangements, a chamfer or other type of leading edge may be used in place of or in addition to such radii.

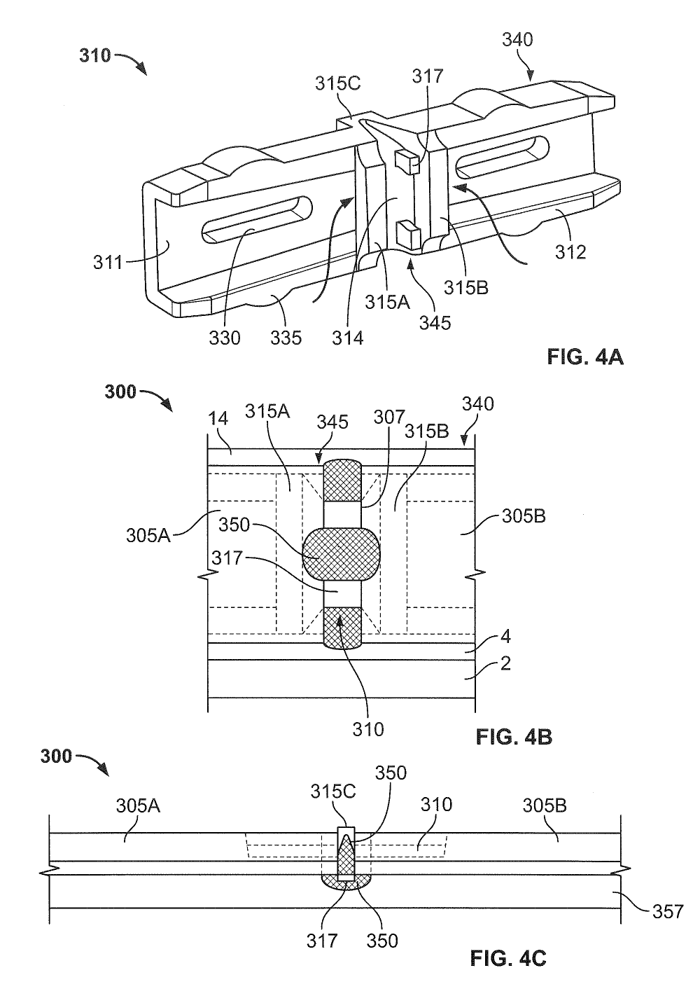

The intermediate section 145 of the spacer key 110 may include a body 114 that may define opposing inner walls of the respective outer sections 140. As shown, the body 114 may be solid such that no gases or fluids, including but not limited to dessicant, may pass through the spacer key 110. In some arrangements, the body 114 may be hollow such that materials such gases or fluids may pass through the body, as is shown and described further herein with respect to the body 314 shown in FIG. 4A.

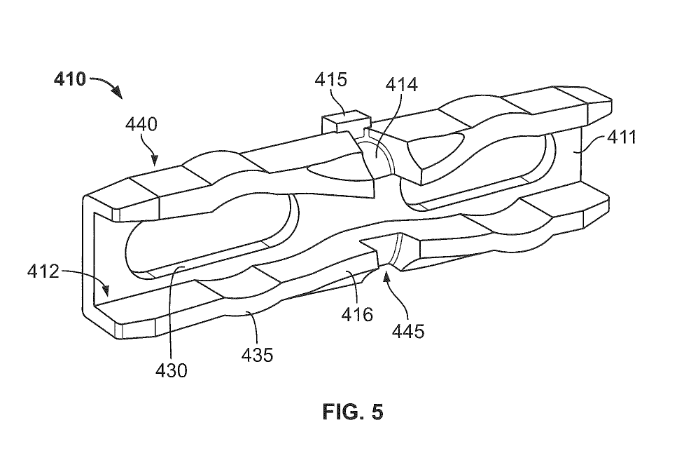

The intermediate section 145 may include a shoulder 115 protruding around the perimeter of the intermediate section 145. In some arrangements, such as in the example of FIG. 2B, the shoulder 115 may protrude around the entire perimeter of the body 114 of the intermediate section 145 while in other arrangements the shoulder may protrude around only a portion of the perimeter (see, for example, shoulder 415 as shown and described with respect to FIG. 5).

In some arrangements, the spacer key 110 may be electrically insulative. Accordingly, materials for the spacer key 110 may be selected from materials such as but not limited to any of nylons (polyamide or a material blend with a polyamide); NORYL (polyphenylene ether or a blend with either or both of a polyphenylene ether and polystyrene); fluoropolymers such as PVDC (polyvinylidene chloride), PCTFE (polychlorotrifluoroethylene), ECTFE (ethylene-chlortrifluorethylene, PVF (polyvinyl fluoride), PVC (polyvinylchloride), PFA (perfluroalkoxy fluorocarbon), and PVDF (polyvinylidene fluoride); TEONEX (polyethylene naphthalate); polyacrylonitrile; PPA (polyphthalamide); PAI (polyamide-imide); PEI (polyetherimide); MYLAR (polyethylene terephthalate); PBT (polybutylene terephthalate); TPU (theremoplastic polyurethane); plastic blends; pyrex or gorilla glass; ceramics such as alumina ceramics, alumina nitride, steatite ceramics such as a magnesium silicate; and metal (aluminum, steel, stainless steel, etc.) which may include an electrically insulative coating. As shown in FIGS. 2A and 2B, the shoulder 115 may abut end faces 107 of each of the respective spacers 105A, 105B. In this manner, when the outer sections 140 of the spacer key 110 are inserted into the respective outer ends of spacers 105A, 105B, the spacer key 110 may electrically isolate the spacer portions 105A, 105B. Thus, in the event that either of the spacer portions 105A and 105B should contact the respective busbar 3, 13, e.g., due to overcompression of the respective spacer portion 105A, 105B, when such busbars are electrically charged, there will not be a short circuit created with the other busbar 3, 13.

In some arrangements, when the shoulder traverses only a portion of the perimeter of the body of the intermediate section, a sealing material may be added to fill any gaps within the shoulder. In some arrangements, the sealing material may be applied adjacent to the shoulder at either or both joints between the intermediate and respective outer sections of the spacer key. Such sealing materials may be but are not limited to being PIB, butyl, ethylene vinyl alcohol (EVOH), epoxides polyvinyl alcohol (PVOH), silicone and blends thereof, polysulfide or polysulphide, thermoplastic polyurethane (TPU), thermoplastic polyurethane elastomer (TPUE), polysulfone (PSU) and blends thereof, polyphenylsulfone (PPSU) and blends thereof, polyethersulfone (PESU) and blends thereof, SAN (styrene acrylonitrile), ASA (acrylonitrile styrene acrylate).

Referring now to FIGS. 3A and 3B, an IGU 200 may be substantially the same as the IGU 100 with the exception that the spacer frame of the IGU may be formed by opposing spacer keys 210 each having an intermediate section 245 and outer sections 240 that are inserted into ends of respective spacers 205A, 205B. The IGU 200 may also include an additional busbar deposited onto the glass lite panel 2. As shown in FIG. 3B, the busbar 23 may extend between the glass lite panel 2 and the spacer seal 4 within a space defined by a length of the intermediate section 245 of the spacer key 210. At least the intermediate section 245 of each spacer key 210, and as shown, the entire spacer key 210 may be made of insulative materials such as those described with respect to the spacer key 110. In this manner, even during overcompression of the spacer key 210 against the spacer seal 4, the spacer key 210 may prevent electrical shorting between the busbar 23 and the spacer portions 205A, 205B.

As best shown in FIG. 3A, the spacer key 210 may be substantially similar to the spacer key 110 with the exception of the intermediate section 245 of the spacer key 210. As shown, the intermediate section 245 may include a base shoulder 215 extending in lengthwise and widthwise directions from a body 214 of the intermediate section 245. Opposing side shoulders 216 may wrap around at least a portion of the perimeter of the body 214. As shown, the opposing side shoulders 216 may wrap around the entire perimeter of the body 214 such that ends of each of the opposing side shoulders 216 are joined with the base shoulder 215. In this manner, the body 214, the base shoulder 215 and the opposing side shoulders 216 may define a U-shaped groove within the intermediate section 245.

A cover, which may be a decorative cover 220 which may be produced in a variety of colors or shapes, may be placed within this U-shaped groove. As shown in FIG. 3A, the cover 220 may include two opposing side panels 224 that may be connected by a cross-panel 225 that may extend between the side panels 224. The cover 220 may be dimensioned such that the cover 220 fills an entire space defined by the U-shaped groove. In some arrangements, as further shown in FIG. 3A, the cover 220 may include a chamfer 228, or some other leading edge such as but not limited to a radius, and the body 214 may include a corresponding chamfer such that a profile of the intermediate section parallel to a longitudinal axis of the intermediate section is the same or substantially the same as the profile of the spacer portions 205A, 205B.

As illustrated in FIG. 3B, the IGU 200 may be assembled such that when the cover 220 is placed over the intermediate section 245 of the spacer key 210 and the spacer key 210 is inserted into the spacer portions 205A, 205B, only the cover 220 may be visible. Sealing material, such as that described previously herein, may be applied at the interface of the spacer key 210 and the spacer portions 205A, 205B.

Referring to FIGS. 4A-4C, a spacer key 310 for insertion into a spacer frame of an IGU 300 for insulative separation of spacer portions of a spacer of the spacer frame may be substantially similar to the spacer key 110 with specific exceptions as described further herein. The spacer key 310 may include an intermediate section 345 situated between and attached to opposing sections 340. As shown, each of the outer sections 340 may include a base 311 that may define a base slot 330 that may one or both allow flexure of the base slot 330 to accommodate spacer dimensional deviations and allow for a reduction in the material needed for the spacer and thus reduce cost. The outer sections 340 may include protrusions 335, which may be but are not limited to being bumps or other types of embossments, jutting from rails 312 that extend from and along the base 311 of the spacer key 310. The protrusions 335 may be rounded to provide a transition from a looser fit to a tighter fit as the outer sections 340 of the spacer key 310 are received within spacer portions 305A, 305B of a spacer frame, as illustrated in FIG. 4B.

The intermediate section 345 of the spacer key 310 may include outer shoulders 315A, 315B that may extend from a body 314 of the spacer key 310. An intersection of the body 314 and each of the rails 312 may define a groove between the rails 312 that may taper from the outer shoulders 315A to an inner shoulder 315C at the intersection of the rails 312. In some arrangements, each of the outer shoulders 315A, 315B may have profiles extending at an oblique angle to a longitudinal axis of the spacer key 310 such that portions of the shoulders 315A, 315B that may be closer to the base 311 are closer to each other than portions of the shoulders 315A, 315B that are further from the base 311. In some arrangements, each of the outer shoulders 315A, 315B may be oriented such that the profiles of the outer shoulders 315A, 315B are perpendicular to a longitudinal axis of the spacer key 310 (not shown). In either of such arrangements, the outer shoulders 315A, 315B may delimitate a region in which to apply a sealing material 350 as described further herein with respect to FIGS. 4B and 4C.

The spacer key 310 may include a boss or a plurality of bosses 317 that may extend from the body 314 in the same direction as the rails 312 extend from the base 311. As shown in FIG. 4B, the outer sections 340 of the spacer key 310, which may be similar to the outer sections described previously herein, may be received within the spacer portions 305A, 305B such that the bosses 317 abut end faces 307 of the respective spacer portions 305A, 305B.

As further illustrated in FIG. 4A, the body 314 of the intermediate section 345 may define a bore through which materials may be passed. In this manner, as in the example of IGU 300, when the spacer key 310 is inserted into the ends of the spacer portions 305A, 305B, dessicant or other absorbent materials conventionally placed within spacer frames to prevent moisture intrusion may flow through the bore of the intermediate section 345 during assembly processing of the IGU.

Referring to FIGS. 4B and 4C, a sealing material 350 such as but not limited to butyl or other materials previously described herein, may be deposited on the body 314. In some arrangements, as shown, the sealing material 350 may be received within the groove defined by the body 314 and the rails 312 and may be received between the outer shoulders 315A, 315B. As best shown in FIG. 4C, the sealing material 350 may be deposited after the spacer key 310 is received within the respective spacer portions 305A, 305B. In this manner, the sealing material 350 may fill the gaps between the spacer key 310 and the respective spacer portions 305A, 305B.

As best shown in FIG. 4C, the bosses 317 and the inner shoulder 315C may each extend beyond the spacer portions 305A, 305B. In some such arrangements, as shown, the sealing material 350 may extend over the bosses 317 and onto ends of the spacer portions 305A, 305B adjacent to the respective joints of the spacer portions 305A, 305B and the bosses 317 of the spacer key 310. As further shown, in some arrangements, a secondary seal 357, such as but not limited to PIB, may be applied over the spacer portions 305A, 305B and the spacer key 310 of the spacer frame of the IGU 300, as known to those of ordinary skill. In this manner, the secondary seal 357 may fill at least a portion of a space defined by the spacer frame and the glass lite panels 2, 12 (not shown) of the IGU 300 in which such a space may be further defined by the surface of the sealing material 350, as further shown in FIG. 4C. In some arrangements, a combination of the spacer key 310, the spacer portions 305A, 305B, and the sealing material 350 form a continuous spacer frame having the same or substantially the same profile as the spacer portions 305A, 305B.

Referring now to FIG. 5, a spacer key 410 for placement in an IGU, such as the IGU 300 or other IGUs described previously herein, may be substantially similar to the spacer key 310 with certain exceptions noted further herein. As shown, the spacer key 410 may include slots 430 that may be larger than the slots 330 of the spacer key 310 and may include protrusions 435, or other types of embossments, that may have curved opposing walls such that each of the protrusions 435 have the same, substantially the same, or even a slightly larger wall thickness as each of the corresponding rails 412 of the spacer key 410. The spacer key 410 may have a body 414 of an intermediate section 445 that may have an open channel that is continuous with open channels formed by bases 411 and rails 412 of outer sections 440 on opposite sides of the intermediate section 445. The body 414 of the intermediate section 445 and the rails 412 of the outer sections 440 may define a groove around an outer portion of a perimeter of the intermediate section 445 of the spacer key 410. In some arrangements, an inner portion of the perimeter of the intermediate section 445 may include a shoulder 415 that may extend across the thickness of the intermediate section 445 of the spacer key 410. As shown, the shoulder 415 may extend beyond the thickness of the rest of the spacer key 410. In this manner, the shoulder 415 may provide a surface for abutment with ends of spacer portions of a spacer. In some arrangements, the shoulder 415 may have a dimension in the thickness direction that is less than or equal to the thickness across the spacer. In this manner, the spacer and not the shoulder 415 may define the separation of the glass lite panels between which the spacer frame may be set.

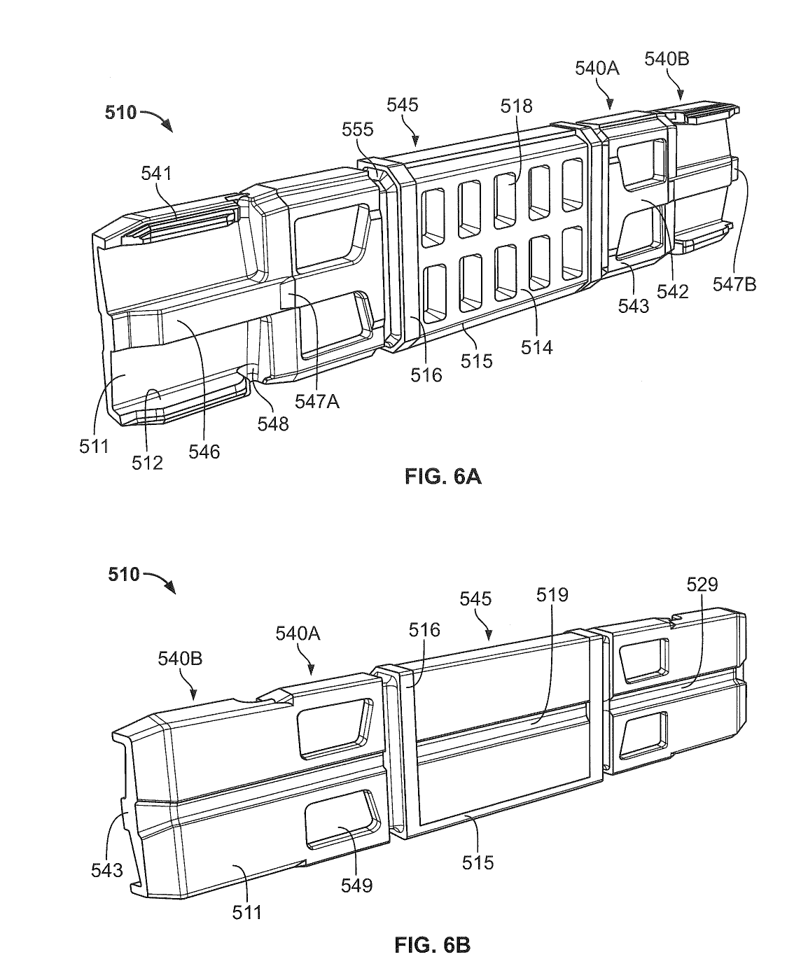

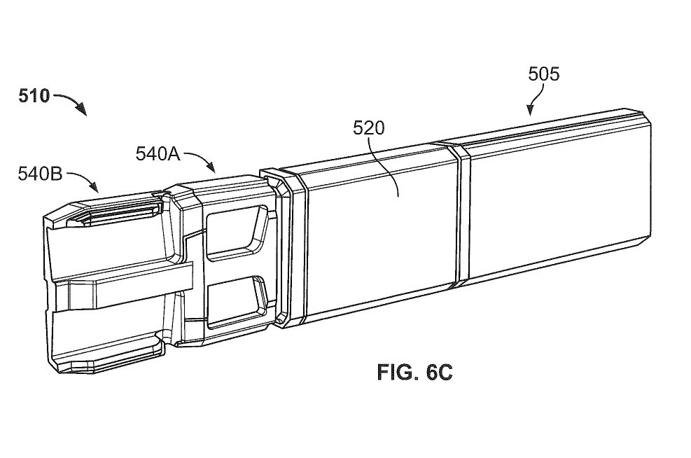

Referring now to FIGS. 6A-6C, a spacer key 510 for placement in IGUs, such as those described previously herein, may be substantially similar to the spacer key 210 with certain exceptions noted further herein. The spacer key 510 may provide insulative separation of spacer portions, such as the spacer portion 505, and busbars of an IGU in a manner similar to that provided by the spacer key 210. As shown in FIG. 6A, the spacer key 510 may include outer sections having first and second outer portions 540A, 540B and an intermediate section 545. As shown in this example, each of the first portions 540A may include a first rib 542 that may be attached to second ribs 543. Each of the first and second ribs 542, 543 may be raised above a base 511 of each of the first and second outer portions 540A, 540B. In some arrangements, as shown, each of the first ribs 542 may be raised above the second rib 543. As further shown, each of the first ribs 542 may be in a T-shape and each of the second ribs 543 may be in an L-shape such that the first and second ribs 542, 543 and the base 511 may define a pair of cavities on each of the first outer portions 540A.

Each of the second outer portions 540B may include rails 512 and a third rib 546 between the rails 512 raised above the base 511 of the outer sections of the spacer key 510. As shown, the third rib 546 may extend from the respective first ribs 542 of the respective first outer portions 540A in a lengthwise direction of the spacer key 510. Each of the first ribs 542 and the third ribs 546 may include respective steps 547A, 547B that may taper from the respective ribs 542, 546 in a direction towards the respective bases 511 of the outer sections. In this manner, the spacer key 510 may be increasingly more compressed as the spacer key 510 is received further into respective spacer portions such as the spacer portion 505 into which the spacer key 510 may be received. Upon insertion into respective spacer portions, the various ribs 542, 543, 546 of the spacer key 510 may provide a compression fit within the respective spacer portions to maintain the spacer key 510 within a spacer frame.

As further shown, the rails 512 may include ridges 541 that may flex to ease the insertion of the spacer key 510 into respective spacer portions, such as the spacer portion 505, while providing a frictional interface with the spacer portions to further aid in maintaining the spacer key 510 within the spacer portions. Each of the outer sections may include a notch 548 defined by the rails 512 of the second outer portions 540B and the second ribs 543. In this manner, the second outer portions 540B may be bent in the widthwise directions to reduce the force required to insert the spacer key 510 into the respective spacer portions of a spacer frame.

As shown in FIG. 6B, on an inner side of the spacer key 510 opposite the rails 512 of the spacer key 510, each of the outer sections of the spacer key 510 may include outer section cavities 549 at various positions which may be used to reduce the amount of material used for the spacer key 510 and thus reduce the costs of processing the spacer key 510 while allowing for reinforced areas around the outer section cavities 549. Each of the bases 511 of the spacer key 510 may define outer section grooves 529 that may serve as tracks for receiving corresponding rails that may extend along the lengths of the respective spacer portions into which the spacer key 510 may be inserted. As shown, the outer section grooves 529 may have ends that flare to aid in aligning the grooves 529 with the corresponding rails of the spacer portions.

As further shown in FIG. 6A, in contrast to the intermediate section 245 of the spacer key 210, on the same side as the rails 512 of the spacer key 510 or outer side of the spacer key 510, the intermediate section 545 of the spacer key 510 may include intermediate section cavities 518. Like the outer section cavities 549, the intermediate section cavities 518 may be used to reduce the amount of material used for the spacer key 510 and thus reduce the costs of processing the spacer key 510. As further shown in FIG. 6A, an intersection of each of the outer portions 540A and the intermediate section 545 may define a groove 555 that may receive a sealing material, such as but not limited to those described with respect to the sealing material 350 described previously herein for sealing an interface between the spacer key 510 and corresponding spacer portions into which the spacer key 510 may be received. Such an arrangement may prevent the leakage of gases from and the introduction of moisture into an IGU cavity defined by the spacer key 510 and corresponding spacer of the spacer frame.

As shown in FIG. 6B, on the inner side of the spacer key 510, the intermediate section 545 may include an intermediate section groove 519 that may extend between opposing side shoulders 516. As shown, the intermediate section groove 519 may be collinear with the outer section grooves 529. As shown in FIG. 6C, a cover 520 may be placed onto the intermediate section 545 in a manner similar to the placement of the cover 220 onto the intermediate section 245 of the spacer key 210. In some arrangements, the cover 520 may have a rail for “tongue-in-groove” insertion of the rail into the intermediate section groove 519 and thus attachment of the cover 520 to the intermediate section 545 of the spacer key 510. As further shown in FIG. 6C, the cover 520 may fit between opposing side shoulders 516 and a base shoulder 515.

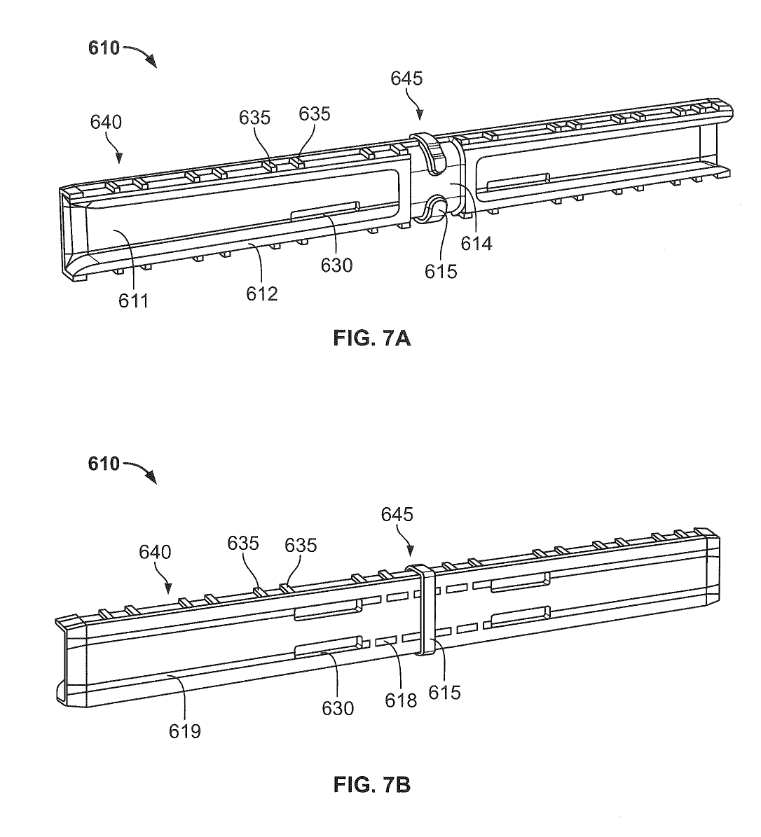

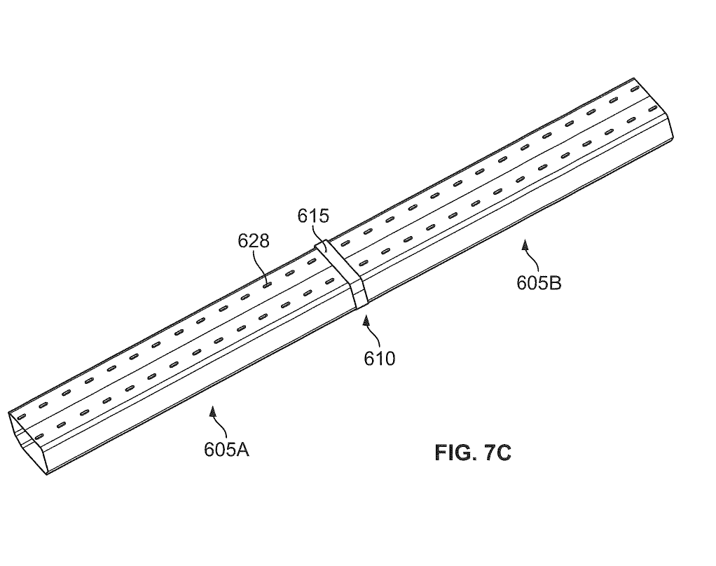

Referring now to FIGS. 7A and 7B, a spacer key 610 may be substantially similar to the spacer key 110 with certain exceptions noted further herein. Accordingly, the spacer key 610 may include outer sections 640 each having tabs 635 placed at predefined positions along rails 612 extending from a base 611. As shown, the tabs 635 may extend in a direction parallel to a widthwise direction of the spacer key 610. As further shown, the length of the outer sections 640 of the spacer key 610 may be greater than the length of the of outer sections 140 of the spacer key 110 and the length of an intermediate section 645 attached to and between each of the outer sections 640 of the spacer key 610 may be greater than the length of the of intermediate section 145 of the spacer key 110.

The intermediate section 645 of the spacer key 610 may have a body 614 that may extend in a widthwise direction from a position that is even with the base 611 to a level below the rails 612 to form a groove defined by the intersections of the outer sections 640 and the intermediate section 645. Such a groove may serve a similar function as each of the grooves 555 described with respect to FIG. 6A. In some arrangements, the body 614 may define a bore which may function in a manner similar to the bore defined by the body 314 of the spacer key 310. In some arrangements, the materials may be passed through the body 614 as described previously herein with respect to the body 314 of the spacer key 310. As further shown, a shoulder 615 may extend around a perimeter of the body 614 in a direction such that the shoulder 615 defines a gap which may receive a sealing material (not shown) in a manner similar to the spacer key 310.

As further shown in FIGS. 7A and 7B, each of the outer sections 640 of the spacer key 610 may include slots 630 therethrough extending in a lengthwise direction. The slots 630 may function in the same or in a similar manner as the base slots 330 shown in and described with respect to FIG. 4A.

Referring to FIGS. 7B and 7C, an inner portion of the spacer key 610 on a side of the spacer key 610 opposite the rails 612 may include cavities 618 and longitudinal grooves 619. As shown, in some arrangements, the longitudinal grooves 619 may be longer than the cavities 618 and may extend along a majority of the length of outer sections 640 of the spacer key 610 to respective ends of the outer sections 640. As shown, in some arrangements, the longitudinal grooves 619 may flare at the extremities of the ends of the outer sections 640.

The spacer key 610 may be received within spacer portions 605A, 605B such that ends of the spacer portions 605A, 605B may abut the shoulder 615 of the spacer key 610. As shown, the spacer portions 605A, 605B may define a plurality of holes or slots 628. In some arrangements, the slots 628 may be formed by punching inwardly through the spacer portions 605A, 605B such that the punched portions of such spacer portions may be received within either or both of the cavities 618 and longitudinal grooves 619. In this manner, the cavities 618 may serve as a grip to receive the punched portions defining the slots 628. In some arrangements, the slots 628 may allow moisture that may be present within an IGU cavity, which may be defined by a spacer frame that includes the spacer portions 605A, 605B and the spacer key 610, to flow therethrough and to be absorbed by desiccant or other absorbent materials that may be within the spacer frame.

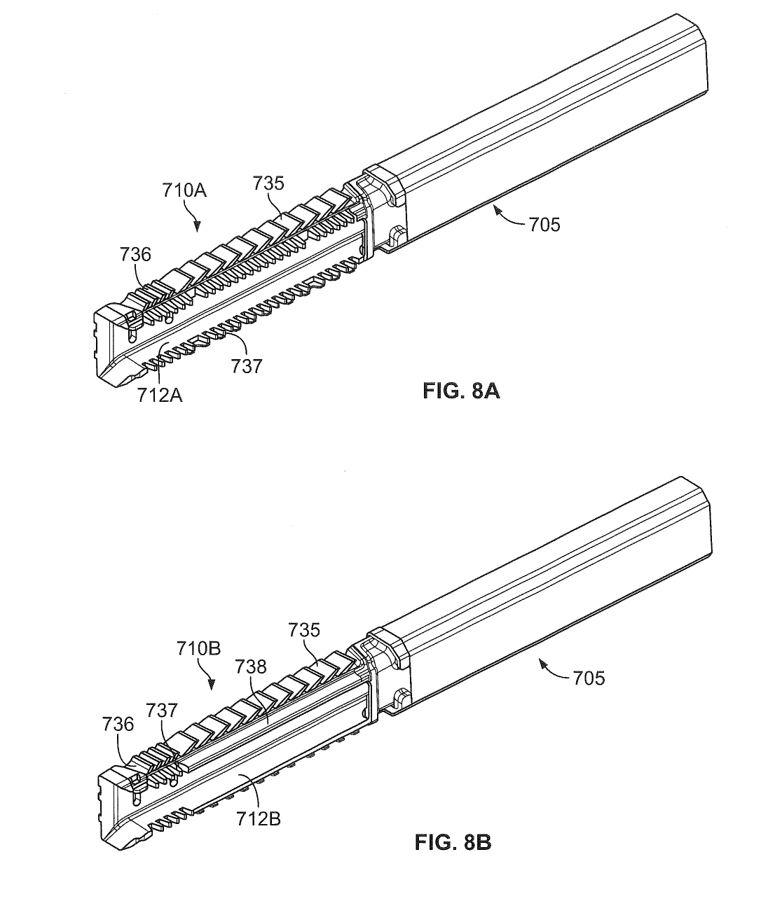

Referring now to FIGS. 8A and 8B, a spacer key 710A and a spacer key 710B may be substantially similar to the spacer key 610 with the exception that respective rails 712A, 712B of the spacer keys 710A, 710B may include different features than the rails 612 of the spacer key 610. As shown in FIGS. 8A and 8B, the rails 712A, 712B may include first fins 735 and second fins 736 that may extend at an oblique direction to the rails 712A, 712B along a surface of the respective spacer keys 710A, 710B connecting inner and outer portions of the respective spacer keys 710A, 710B. In some arrangements, such fins may extend in a direction opposite a direction in which outer sections of the respective spacer keys 710A, 710B may be received within ends of spacer portions, such as the spacer portion 705 that may be the same or substantially similar to the spacer portions 605A, 605B shown in FIG. 6C. In this manner, the fins may allow for easier insertion of the respective spacer keys 710A, 710B into the ends of the spacer portions but provide additional friction between the respective spacer keys and the corresponding spacer portions in a direction opposite the direction of insertion. As shown, the first fins 735 may be longer than the second fins 736. In this manner, the first fins 735 may provide for greater compression and thus increased friction between the respective spacer keys 710A, 710B and the corresponding spacer portions.

As shown in FIG. 8A, the rails 712A of the spacer key 710A may include third fins 737 that may extend along the length of the rails 712A in a widthwise direction. In contrast, as shown in FIG. 8B, the rails 712B of the spacer key 710B may include the third fins 737 that may extend only along an end portion of the rails 712B. As further shown in FIG. 8B, a remainder of the rails 712B may be solid. In either of the arrangements of FIGS. 8A and 8B, the third fins 737 may allow for easier insertion of the respective spacer keys 710A, 710B in a manner similar to the first and second fins 735, 736. In some arrangements, any or all of the first fins 735, the second fins 736, and the third fins 737 may extend from any location on the rails, e.g., any of the front, the rear, the top, and the bottom surfaces of the rails.

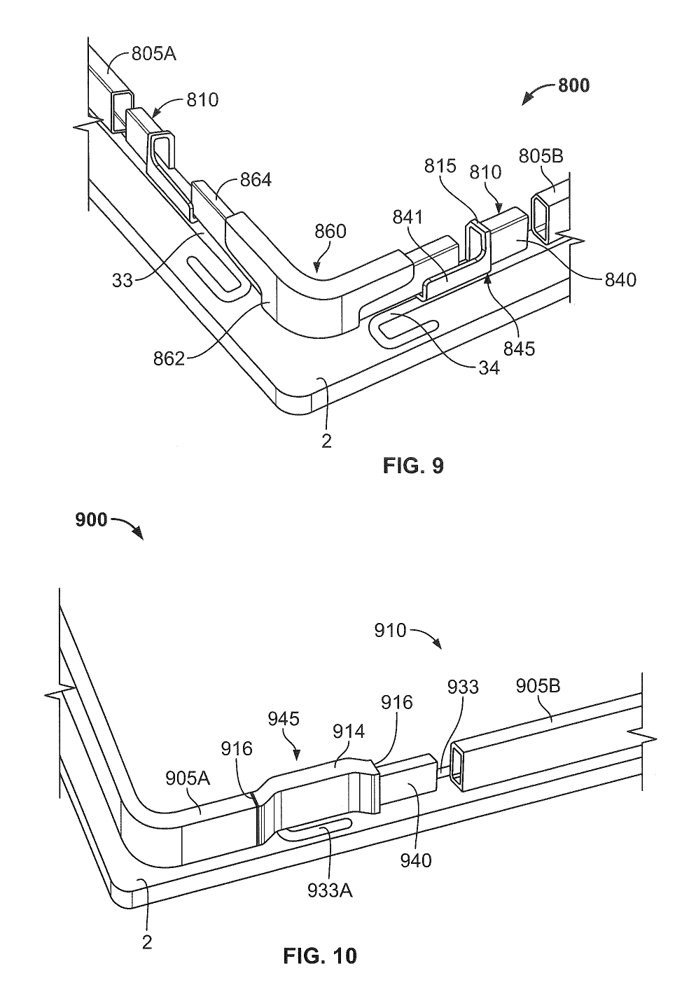

Referring now to FIG. 9, an IGU 800 may include a glass lite panel 2 that may have a busbar 33 and a busbar 34 that may each be applied to and may run along in a direction parallel to an edge of the glass lite panel 2. As shown, ends of the busbars 33, 34 may be adjacent to each other in a corner of the IGU 800. As further shown, the IGU 800 may include a spacer frame that may be formed by spacer portions 805A, 805B that may extend from spacer keys 810 which in turn may extend from a spacer corner 860. Although not shown, a spacer seal conventionally may be placed between the spacer frame and the glass lite panel 2.

The spacer corner 860 may have a corner section 862 from which corner tongues 864 may extend. The spacer corner 860 may be rigid. The spacer corner 860 may be made of materials such as stainless steel, other metals, plastics, or ceramics.

The spacer keys 810 may include a first outer section 840 and a second outer section 841 which may be on opposing sides of and may be attached to an intermediate section 845. As shown, in some arrangements, the intermediate section 845 may include a shoulder 815, although in other arrangements, the intermediate section 845 may be but is not limited to being substantially similar to intermediate sections described previously herein. Each of the first outer sections 840 may be dimensioned to be received within the respective spacer portions 805A, 805B. As shown, the first outer section 840 may be a hollow tube, although in other arrangements, the first outer sections 840 may be but is not limited to being arranged in a manner similar to the outer sections such as any of the outer sections described previously herein.

As further shown, each of the second outer sections 841 may have a length that may act as a shelf for supporting the respective corner tongues 864. The second outer section 841 may further have a thickness along at least a portion of the width such that the second outer section 841 may overlap with a portion of the corner section 862 of the spacer corner 860 to provide an exposed surface along a portion of the spacer frame. The respective spacer keys 810 may be made of insulative materials such as but not limited to those described with respect to the spacer key 110. In this manner, the spacer keys 810 may prevent electrical shorting between the busbars 33 and 34 in the event of inadvertent contact and shorting between either of the busbars 33, 34 and the respective spacer portions 805A, 805B.

Referring now to FIG. 10, an IGU 900 may include a glass lite panel 2 that may have a busbar 933 that may run along in a direction parallel to an edge of the glass lite panel 2. As shown, the busbar 933 may have a busbar end 933A that be adjacent to the edge of the glass lite panel 2. As further shown, the IGU 900 may include a spacer frame that may be formed by spacer portions 905A, 905B that may extend from outer sections 940 of a spacer key 910. Although not shown, a spacer seal conventionally may be placed between the spacer frame and the glass lite panel 2.

As further shown, the spacer key 910 may include an intermediate section 945 between and attached to the outer sections 940. The intermediate section may include a body 914 and may include opposing shoulders 916 on ends of the body 914 for abutment against ends of the spacer portions 905A, 905B. As shown, in this arrangement, a central portion of the body 914 may be offset from the outer sections 940. In this manner, the busbar end 933A may fit within an area defined by the body 914 and the edge of the glass lite panel 2. As shown in FIG. 10, it is believed that such an arrangement will allow the spacer frame to be placed closer to the edge of the glass lite panel 2 to provide for a greater viewing area within an IGU when installed in an architectural glazing frame.

Although some aspects, embodiments, and arrangements described previously herein have been described as having male and female or equivalent interfaces or connections, it is to be understood that such aspects, embodiments, and arrangements include the reversal of such male and female interfaces. For example, where spacer key outer sections are described as being received within spacer portions, in other arrangements, certain features of the outer sections and the spacer portions, such as the respective interfacing outer perimeters, may be reversed such that the outer sections may receive the spacer portions. As another example, where a rail, bump, boss, tab, protrusion or similar male feature is described as being received in or similarly interfacing with a groove, a slot, a cavity, or other female feature, such respective features may be reversed.

Although some aspects, embodiments, and arrangements described previously herein have been described as having seals, sealants, sealing mechanisms, and the like, it is to be understood that such aspects, embodiments, and arrangements may include all, some, or none of such seals, sealants, sealing mechanisms, and the like. It is to be understood that any gaps at the interfaces of any components may be sealed by seals, sealants such as those described previously herein with respect to FIGS. 4B and 4C, sealing mechanisms, and the like, including but not limited to gaskets, o-rings, silicone, PIB, and any other sealing mechanisms known to those of ordinary skill for use in each particular application. Although some aspects, embodiments, and arrangements described previously herein have been described as having one or a plurality of feed-through mechanisms, assemblies, connectors, and the like, it is to be understood that such aspects, embodiments, and arrangements may include either one or a plurality of such feed-through mechanisms, assemblies, connectors, and the like.

It is to be understood that the disclosure set forth herein includes all possible combinations of the particular features set forth above, whether specifically disclosed herein or not. For example, where a particular feature is disclosed in the context of a particular aspect, arrangement, configuration, or embodiment, or a particular claim, that feature can also be used, to the extent possible, in combination with and/or in the context of other particular aspects, arrangements, configurations, and embodiments of the invention, and in the invention generally.

Furthermore, although the invention herein has been described with reference to particular features, it is to be understood that these features are merely illustrative of the principles and applications of the present invention. It is therefore to be understood that numerous modifications, including changes in the sizes of the various features described herein, may be made to the illustrative embodiments and that other arrangements may be devised without departing from the spirit and scope of the present invention. In this regard, the present invention encompasses numerous additional features in addition to those specific features set forth in the claims below. Moreover, the foregoing disclosure should be taken by way of illustration rather than by way of limitation as the present invention is defined by the claims set forth below.

1. An insulative separation element bridging first and second conductive spacer ends of a spacer frame of an active or insulated glazing unit comprising:
first and second outer sections dimensioned for placement into the first and second conductive spacer ends of the spacer frame; and
an intermediate section connecting the first and second outer sections, the intermediate section having opposing first and second faces dimensioned for abutment with and insulative separation of the first and second spacer ends, respectively.

2. The insulative separation element of claim 1, wherein at least the first outer section has a base and opposing rails spaced apart and extending from and parallel to the base, the opposing rails and base defining a fillable space.

3. The insulative separation element of claim 2, wherein the opposing rails are dimensioned for compressive engagement with the first and second conductive spacer ends of the active or insulated glazing unit.

4. The insulative separation element of claim 2, wherein a plurality of fins extend from the rails.

5. The insulative separation element of claim 4, wherein the fins extend at a first angle along a first portion of the rails and extend at a second angle along a second portion of the rails.

6. The insulative separation element of claim 2, wherein an underside of the base opposite the opposing rails includes cavities therein.

7. The insulative separation element of claim 1, wherein the intermediate section defines a bore through which material may pass from either of the first and second outer sections to the other of the first and second outer sections.

8. The insulative separation element of claim 1, wherein an exterior of the intermediate section includes a groove, further comprising a removable cover receivable in the groove.

9. The insulative separation element of claim 8, wherein the groove of the intermediate section is formed on inner and outer sides and on a first end of the intermediate section, the first end being opposite a second end of the intermediate section, such that a cross-section of the groove has a U-shape.

10. The insulative separation element of claim 9, wherein a cross-section of the removable cover has a shape corresponding to the U-shape cross-section of the groove of the intermediate section such that, upon placement of the removable cover onto the intermediate section, three surfaces of the removable cover are flush against each of the inner and outer sides and the first end of the intermediate section, respectively.

11. The insulative separation element of claim 9, wherein the groove forms an insulative shoulder at the second end of the insulative separation element.

12. The insulative separation element of claim 8, wherein one of the intermediate section and the removable cover includes a protrusion and the other of the intermediate section and the removable cover includes a protrusion groove dimensioned for receiving the protrusion such that when the protrusion is received in the protrusion groove, the removable cover is lockingly engaged with the intermediate section.

13. The insulative separation element of claim 1, further comprising a plurality of fins extending from at least one of the first and second outer sections.

14. The insulative separation element of claim 13, wherein the plurality of fins extend from only an end portion of the at least one of the first and second outer sections.

15. The insulative separation element of claim 13, wherein at least some of the fins extend at an angle towards the intermediate section.

16. The insulative separation element of claim 1, further comprising compressible protrusions extending from the outer sections for providing a press fit with the first and second conductive spacer ends of the spacer frame.

17. The insulative separation element of claim 1, wherein the intermediate section is a shoulder extending along only a portion of the perimeter of the intermediate section.

18. The insulative separation element of claim 1, wherein the outer sections have a first central axis passing therethrough, and wherein the intermediate section has a second central axis passing therethrough, the first and second central axes being parallel to and offset from each other.

19. The insulative separation element of claim 1, wherein the intermediate section includes a shoulder, further comprising grooves adjacent to the shoulder, the grooves being defined by the intersection of the respective outer sections and the intermediate section.

20. An active or insulated glazing unit comprising:
an insulative separation element; and
first and second spacer portions of a spacer frame, the first and second spacer portions being conductive,
wherein the insulative separation element matingly engages the first and second spacer portions, the insulative separation element electrically isolating the first and second spacer portions.

21. The active or insulated glazing unit of claim 20,
wherein the insulative separation element includes a shoulder having at least one shoulder surface abutting a spacer surface of each of the first and second spacer portions such that the insulative separation element and the first and second spacer portions form a continuous common outer profile when the insulative separation element fully engages the first and second spacer portions.

22. The active or insulated glazing unit of claim 20, the insulative separation element including a pair of outer sections for connecting the first and second spacer portions, the outer sections separated by an intermediate section connected thereto,
wherein a first longitudinal axis passes through each of the first and second spacer portions,
wherein a second longitudinal axis passes through the intermediate section, and
wherein the first and second longitudinal axes are offset from and parallel to each other.

23. The active or insulated glazing unit of claim 20, further comprising a plurality of spaced apart conductive traces deposited on a substrate thereof,
wherein the insulative separation element includes an insulative shoulder element along a side thereof, and
wherein upon contact of the insulative separation element with a corresponding conductive trace, the insulative shoulder element contacts a corresponding one of the conductive trace such that no electrical interconnection is formed between the insulative separation element and the corresponding conductive trace.

24. The active or insulated glazing unit of claim 20, the insulative separation element including a pair of outer sections for connecting the first and second spacer portions, the outer sections separated by an intermediate section connected thereto, wherein the outer sections of the insulative separation element are compressively received within the first and second spacer portions.

25. The active or insulated glazing unit of claim 20, wherein the insulative separation element includes separated shoulders defining a gap, the active or insulated glazing unit further comprising a sealing material placed within the gap.

26. The active or insulated glazing unit of claim 20, the insulative separation element including an outer section and a shelf connected by an intermediate section for connecting the first and second spacer portions, wherein the first spacer portion includes a tongue that rests on the shelf of the insulative separation element.

27. The active or insulated glazing unit of claim 26, wherein the tongue of the first spacer portion is received within the outer section of the insulative separation element, and wherein the outer section of the insulative separation element is received within the second spacer portion.

28. The active or insulated glazing unit of claim 26, further comprising:
a third spacer portion; and
a second insulative separation element on a side of the first spacer portion opposite the insulative separation element,
wherein the second insulative separation element electrically isolates the first spacer portion from the third spacer portion.

29. The active or insulated glazing unit of claim 28, wherein the first spacer portion forms a corner of the active or insulated glazing unit.
